(19) United States
(12) Patent Application Publication
(10) Pub. No.: US 2011/0143661 A1
(43) Pub. Date: Jun. 16, 2011

(54) METHOD, DEVICE AND SYSTEM FOR FIRMWARE UPDATE BY NEAR-FIELD COMMUNICATION

(75) Inventors: Stephan Hartwig, Essen (DE); Janne Paavo Ristoppi Jalkanen, Espoo (FI)

(73) Assignee: NOKIA CORPORATION, Espoo (FI)

(21) Appl. No.: 12/745,678

(22) PCT Filed: Nov. 30, 2007
(86) PCT No.: PCT/IB07/03695

§ 371 Date: Nov. 12, 2010

(51) Int. Cl. H04B 5/00

(52) U.S. Cl. 455/41.1

(57) ABSTRACT

The present invention relates to a method, comprising receiving patch data via contactless communication comprising a patch for a patchable firmware and patch identification information; and patching said firmware using said patch.

The present invention relates to a method, device and system for updating the firmware of devices having a patchable firmware.

### PRIOR ART

There are many embedded devices in an industrial or home context like programmable thermostats, window blind timers, dishwashers, etc., having a piece of controlling software usually referred to as “firmware”. The firmware is a vital part of each hardware device, because it influences all functions of the respective device. Due to the increasing complexity of such devices it becomes more and more common that certain errors in the firmware are discovered over time or new functions shall be added to the device. In such cases an update or patching of the firmware is desired.

If the firmware is stored within a read-only memory like a ROM, it can only be replaced by replacing the complete ROM. This may not be feasible in some devices, for example due to the costs that are involved in a replacement. Therefore it is known to provide an additional writable memory or “patch memory”, for example a flash ROM, an EEPROM, a RAM (in this case also called patch RAM) or like, in the device. In this manner it is possible to provide update data in this patch memory to replace certain parts of or supplement the firmware in the ROM. In other words; certain parts of the firmware in the ROM are being “skipped” while corresponding code from the patch memory is used instead (e.g. by letting the program counter jump into and out of a software patch in the patch memory), or new code is added to provide new functionality.

Some devices have e.g. infrared interfaces for firmware updates, but these are expensive and cannot be used by most consumers. Moreover, some embedded devices with special requirements on tolerance against certain ambient conditions (waterproof, vapor proof, shock resistant etc.) or at locations making it difficult to access/remove these devices, cannot be disassembled or decently accessed. Examples could include the control unit in a dishwasher, which one may be able to access in principle, but which is difficult to remove from the device and which is difficult to close in a waterproof manner after opening. Examples of such devices or appliances could also include a hard to move object such as a washing machine, or a difficult to access item like an automotive control box in a car.

Thus, once consumer devices are in use or installed, they become complicated to maintain. If there are errors or bugs in the firmware of the device, it is very expensive to fix them, because it usually requires manual work from a skilled technician who needs to travel. At least it requires that a user is technically skilled in replacing parts or applying a firmware update, if the update is to be performed by the user.

The NFC Data Exchange Format (NDEF) specification NFCForum-TS-NDEF_{—}1.0 2006-07-24 defines a message encapsulation format to exchange information, e.g. between an NFC Forum Device and another NFC Forum Device or an NFC Forum Tag. Details can be found on the Internet at http://www.nfc-forum.org/home.

NDEF is a lightweight, binary message format that can be used to encapsulate one or more application-defined payloads of arbitrary type and size into a single message construct. Each payload is described by a type, a length, and an optional identifier. Type identifiers may be URIs, MIME media types, or NFC-specific types. This latter format permits compact identification of well-known types commonly used in NFC Forum applications, or self-allocation of a name space for organizations that wish to use it for their own NFC-specific purposes.

The payload length is an unsigned integer indicating the number of octets in the payload. A compact, short-record layout is provided for very small payloads. The optional payload identifier enables association of multiple payloads and cross-referencing between them. NDEF payloads may include nested NDEF messages or chains of linked chunks of length unknown at the time the data is generated.

NDEF is strictly a message format, which provides no concept of a connection or of a logical circuit, nor does it address head-of-line problems. The NFC Data Exchange Format (NDEF) specification is a common data format for NFC Forum Devices and NFC Forum Tags. The NFC Data Exchange Format specification defines the NDEF data structure format as well as rules to construct a valid NDEF message as an ordered and unbroken collection of NDEF records. Furthermore, it defines the mechanism for specifying the types of application data encapsulated in NDEF records.

The NDEF specification defines only the data structure format to exchange application or service specific data in an interoperable way, and it does not define any record types in detail. The NDEF specification assumes a reliable underlying protocol and therefore it does not specify the data exchange between two NFC Forum Devices or the data exchange between an NFC Forum Device and an NFC Forum Tag.

An example of the use of NDEF is when two NFC Forum Devices are in proximity, an NDEF message is exchanged over the NFC Forum LLCP protocol. When an NFC Forum Device is in proximity of an NFC Forum Tag, an NDEF message is retrieved from the NFC Forum Tag by means of the NFC Forum Tag protocols. The data format of the NDEF message is the same in these two cases so that an NFC Forum Device may process the NDEF information independent of the type of device or tag with which it is communicating.

NDEF does not make any assumptions about the types of payloads that are carried within NDEF messages or about the message exchange patterns implied by such messages.

### SUMMARY OF THE INVENTION

According to a first aspect of the invention a method is provided, comprising:
receiving patch data via contactless communication comprising a patch for a patchable firmware and patch identification information; and
patching said firmware using said patch.

If a consumer has a problem with an embedded device caused by faulty firmware, or also in case of added new features, he can obtain a firmware update—e.g. in form of an RFID tag. This tag could be delivered to the consumer by mail. The benefit is that the consumer is not forced to remove the device from its location. Therefore the invention enables to update even devices that are usually stationary and/or difficult to access. Moreover, the invention entails reduced service costs for the manufacturer, due to the fact that expensive visits of technical personnel can be avoided. It also enables the option for a manufacturer to provide firmware updates installing new features for its installed base of products.

The patch identification information allows the device to be updated to recognize a patch and distinguish it from any other data provided via contactless communication.

According to an embodiment of the invention the patch is offered in an NFC-formatted data format, for example NFC data exchange format NDEF. The specification for NDEF can be downloaded from the NFC Forum at http://www.nfc-forum.org/specs/ after registration.

According to an exemplary embodiment said patch identification information includes at least one of:
patch data type;
manufacturer identification;
device identification; and
patch version.

According to an exemplary embodiment the method further comprises
verifying said patch by checking at least one of patch data type, manufacturer identification, device identification and patch version;
   wherein patching of said firmware is performed responsive to a positive verification for each checked item.

According to an exemplary embodiment said verifying comprises checking if said patch identification information includes a patch data type, and establishing a positive verification if said patch data type is included.

According to an exemplary embodiment said checking comprises checking a manufacturer identification in said patch identification information, and establishing a positive verification if said manufacturer identification corresponds to pre-determined manufacturer information.

According to an exemplary embodiment said checking comprises checking a device identification in said patch identification information, and establishing a positive verification if said device identification corresponds to a pre-determined device identification.

According to an exemplary embodiment said checking comprises checking a patch version in said patch identification information, and establishing a positive verification if said patch version is more recent than and/or directly succeeds the version of said firmware.

According to an exemplary embodiment said patch data further comprise patch integrity information, and wherein said verifying of said patch further comprises checking said patch integrity information, and establishing a positive verification if said patch integrity information is valid.

The integrity of an update is very important, because applying a faulty or even intentionally manipulated update could render the device useless. Therefore the integrity can be checked, e.g. by using a check sum. According to the invention the patch integrity information may include a checksum (e.g. Cyclic Redundancy Check CRC) for checking the data content of the patch, a hamming code for error correction purposes, an issuer certificate for authenticating the source/supplier of the patch, and a cryptographic key for limiting the use of the patch. These are just examples of elements that can be included in the patch integrity information.

It is to be noted that in the context of the invention the term “integrity” should be understood as including both the code or data integrity as well as the integrity of the source of a patch. For example, in principle a patch may have a data content with intact integrity, i.e. not bits have been corrupted, but it may still originate from an unreliable or not trustworthy source, e.g. someone trying to spread a virus or other kind of malicious software (“malware”). Therefore usually both aspects should be checked, e.g. by checking data integrity using CRC and checking that the source is trustworthy by verifying a supplier certificate.

Moreover, it has to be ensured that an update is applied to the right device, thus a device identification could be used to make sure that the firmware patch is for the right type/model of device. As there may be different sub-versions of a device, i.e. even devices of one product type or model often have differing versions as they evolve over time this device identification can include a full product code and not just the model number.

Still, even if the patch is intended for the device to be updated and has an intact integrity, it may be a wrong update with respect to the number/version of patches. That is, applying a patch from a succession of patches may require using it in the correct order, i.e. only after any previous patch has been applied. In this case the patch version must directly succeed the current firmware version. In other embodiments each may patch include all previous patches, so that it is only required that the patch version is more recent than the current firmware version. It may be desired to exclude the possibility of “downgrading” of a firmware, i.e. applying a previous patch to a device with an up to date firmware.

It is to be noted that the above mentioned checks can be combined in any manner, for example by checking patch data type, device identification and patch integrity, and only applying the patch when all checked entries can be confirmed to indicate compatibility with the device to be updated.

According to an exemplary embodiment said patch data are received at a first module having a contactless communication interface, the method further comprising:
forwarding said patch data to a second module.

This embodiment may be used in complex devices or systems having two or more modules connected by an interface, wherein only one of the modules needs to have a contactless communication interface. Therefore the patch is received at the module with the contactless communication interface, which may be located to facilitate access. Through the interface, e.g. a bus, the patch can be forwarded to the second module (or generally all others modules in case of a plurality of modules), which may itself be difficult to access or even unreachable.

According to an exemplary embodiment said firmware patch is received at an NFC tag, and the method comprises
downloading said patch into a mobile device having an NFC interface capable of writer mode operation; and
providing said patch to said NFC tag via said NFC interface in writer mode.

According to this exemplary embodiment the patch data or firmware update can be downloaded, e.g. from the manufacturer's web page or any other source. This can be performed by a PC or a mobile device such as a phone that has a service connection to get access to the interne and an NFC writer function to write the downloaded patch onto the NFC tag.

According to an exemplary embodiment said patch is received at an NFC interface capable of peer-to-peer mode operation, comprising
downloading said patch into a mobile device having an NEC interface capable of peer-to-peer mode operation; and
providing said patch from said mobile device to said NFC interface in peer-to-peer communication.

According to an exemplary embodiment said firmware patch is received at an NFC interface capable of reader mode operation, comprising
downloading said patch into a mobile device having an NFC writer;
writing said patch to an NFC tag using said NFC writer; and
providing said patch to said NFC interface using said NFC tag.

This embodiment allows the patch to be written to an NFC tag for performing the update function. In this case the device to be updated comprises an embedded NFC reader, and the firmware update is delivered by an NFC tag, e.g. by simply placing it onto a certain section of the housing, or inserting the tag (or generally a medium carrying the tag) into a slot, aperture or similar receptacle. A carrier medium can for example be a plastic or paper card, or a cylindrical tube.

According to an exemplary embodiment said firmware patch is received at an NFC interface capable of reader mode operation, comprising
downloading said patch into a mobile device having an NFC interface capable of NFC tag emulation mode operation;
emulating an NFC tag using said mobile device; and
providing said patch to said NEC interface via said emulated NFC tag.

According to an exemplary embodiment said patch is received at an NFC interface capable of reader mode operation, comprising
providing said patch to said NFC interface using an NFC tag.

The NFC tag can be provided to a user via normal mail service or in any suitable manner, for example be given to a user in a retail shop or like. In case of an NFC reader the apparatus can be adapted to perform a read operation to discover NFC tags in range upon activation or power-up, respectively. A special key combination can be used to trigger the update process, like pressing play, stop and eject button simultaneously. Or the apparatus can be adapted to perform such discovery regularly, e.g. every 60 seconds.

The above described embodiments include the following combinations:

1) Writing a patch to an NFC tag embedded in the apparatus to be updated using a mobile device comprising the patch and having an NFC interface capable of writer mode operation.

2) Establishing a peer-to-peer connection between a mobile device comprising the patch and having an NFC interface capable of peer-to-peer communication and a peer-to-peer capable NFC interface embedded in the device to be updated.

3) Emulating an NFC tag by a mobile device comprising the patch and having an NFC interface capable of tag emulation mode operation, and applying the emulated “tag” to an NFC reader in the device to be updated.

4) Applying an NFC tag comprising the patch to an NFC reader in the device to be updated.

That is, any combination of device A having the patch and device B to be updated is possible, wherein device A can be a tag writer, peer-to-peer capable device, a device capable of tag emulation or a tag, and device B can be a tag, a peer-to-peer capable device or a tag reader. In the context of the invention an NFC interface is an interface between any of tag writer, tag, peer-to-peer device, reader, and tag emulating device.

According to a second aspect of the invention a computer program product is provided, comprising program code to instruct a device on which said program product runs to perform a method as described above. In an exemplary embodiment the program code is stored on a computer readable medium.

According to a third aspect of the invention an apparatus is provided, comprising
a memory component configured for storing a patchable firmware;
a contactless communication interface; and
a controller circuitry;
   wherein said controller circuitry is configured to receive patch data via said contactless communication interface comprising a patch for said firmware and patch identification information, and to patch said firmware using said patch.

In this manner the apparatus can be designed according to its specific requirements, including being waterproof, vapor proof, shock resistant etc., while still being able to receive firmware updates. No opening or disassembling of the apparatus is necessary for a firmware update, and any shielding, sealing etc. remains intact.

It is to be noted that the term “memory component” is to be understood as including all kinds of memory modules for storing a patchable firmware and/or a patch for it, e.g. a (single) flash memory module as well as a memory comprising a read-only memory (ROM) unit together with a writable random access memory (RAM), also called a patch RAM. In the former example the firmware is stored in the writable flash ROM, wherein parts of the or also the complete firmware can be replaced. In the latter example the ROM stores the initial or original firmware that cannot be changed by itself, and the patch RAM can be used to store firmware sections that are to replace certain firmware sections in the ROM. This can e.g. be achieved by performing “jumps” at certain memory addresses in the ROM, such that the corresponding patched/updated code in the patch RAM is used.

According to an exemplary embodiment said patch identification information includes at least one of:
patch data type;
manufacturer identification;
device identification; and
patch version;
   wherein said controller circuitry is configured to verify said patch by checking at least one of patch data type, manufacturer identification, device identification and patch version and to perform said patching of said firmware responsive to a positive verification of each checked item.

According to an exemplary embodiment said checking comprises checking if said patch identification information includes a patch data type, and establishing a positive verification if said patch data type is included.

According to an exemplary embodiment said checking comprises checking a manufacturer identification in said patch identification information, and establishing a positive verification if said manufacturer identification corresponds to pre-determined manufacturer information.

According to an exemplary embodiment said checking comprises checking a device identification in said patch identification information, and establishing a positive verification if said device identification corresponds to a pre-determined device identification.

According to an exemplary embodiment said checking comprises checking a patch version in said patch identification information, and establishing a positive verification if said patch version is more recent than and/or directly succeeds said firmware version.

According to an exemplary embodiment said patch data further comprise patch integrity information, and wherein said verifying of said patch further comprises checking said patch integrity information, and establishing a positive verification if said patch integrity information is valid.

According to an exemplary embodiment the apparatus further comprises
a trigger circuitry configured to detect an approach of an NFC tag to said apparatus;
   wherein said controller circuitry is configured to be activated responsive to a detected approach.

According to an exemplary embodiment said trigger circuitry is configured to detect an approach of an NFC tag by detecting an insertion of said NFC tag or a carrier medium carrying said NFC tag into said apparatus.

The apparatus can be equipped to detect when an NFC tag is brought into close proximity, and then activate the controller circuitry only on demand. This can reduce the power consumption and reduces unnecessary activation of the reader.

For example the apparatus can be provided with a slot, aperture or other receptacle for receiving an update medium including the NFC tag, for example in form of a credit-card like medium. The trigger circuit can be embodied as an electric, magnetic, opto-electronic or mechanic switch or combination thereof to detect insertion of the firmware update medium. In this manner, the physical insertion of a tag (e.g. a card) into the receptacle can trigger a built-in device reader so that the reader wouldn't have to poll permanently.

According to an exemplary embodiment said contactless communication interface comprises one of:
an NFC interface configured for reader mode operation;
an NFC interface configured for peer-to-peer mode operation;
an NFC tag;
an NFC interface configured for NFC tag emulation mode operation;
an RFID interface configured for reader mode operation;
an RFID tag; and
an RFID interface configured for RFID tag emulation mode operation.

According to a fourth aspect of the invention a system is provided, comprising
a first module comprising a contactless communication interface;
at least one second module comprising a memory component configured for storing a patchable firmware;
an interface connecting said first and said second module;
a first controller circuitry in said first module; and
a second controller circuitry in said at least one second module;
   wherein said first controller circuitry is configured to receive patch data via said contactless communication interface comprising a patch for said firmware and patch identification information, and to forward said patch data from said first module to said at least one second module via said interface, and wherein said at least one second controller circuitry is configured to patch said firmware using said patch.

According to an exemplary embodiment said contactless communication interface comprises one of:
an NFC interface configured for reader mode operation;
an NFC interface configured for peer-to-peer mode operation;
an NFC tag;
an NFC interface configured for NFC tag emulation mode operation;
an RFID interface configured for reader mode operation;
an RFID tag; and
an RFID interface configured for RFID tag emulation mode operation.

According to an exemplary embodiment said patch identification information includes at least one of:
patch data type;
manufacturer identification;
device identification; and
patch version;
   wherein said second controller circuitry is configured to verify said patch by checking at least one of patch data type, manufacturer identification, device identification and patch version and to perform said patching of said firmware responsive to a positive verification of each checked item.

According to an exemplary embodiment said checking comprises checking if said patch identification information includes a patch data type, and establishing a positive verification if said patch data type is included.

According to an exemplary embodiment said checking comprises checking a manufacturer identification in said patch identification information, and establishing a positive verification if said manufacturer identification corresponds to pre-determined manufacturer information.

According to an exemplary embodiment said checking comprises checking a device identification in said patch identification information, and establishing a positive verification if said device identification corresponds to a pre-determined device identification.

According to an exemplary embodiment said checking comprises checking a patch version in said patch identification information, and establishing a positive verification if said patch version is more recent than and/or directly succeeds said firmware version.

According to an exemplary embodiment said patch data further comprise patch integrity information, and wherein said verifying of said patch further comprises checking said patch integrity information, and establishing a positive verification if said patch integrity information is valid.

### BRIEF DESCRIPTION OF THE DRAWINGS

The invention can be more fully understood by the following detailed description of exemplary embodiments, when also referring to the drawings, which are provided in an exemplary manner only and are not intended to limit the invention to any particular embodiment illustrated therein. In the drawings

FIG. 1 shows a flow diagram of an embodiment of a method according to the invention;

FIG. 2 shows an embodiment of a device according to the invention;

FIG. 3 shows a first alternative embodiment of a device according to the invention;

FIG. 4 shows a second alternative embodiment of a device according to the invention;

FIG. 5 shows a third alternative embodiment of a device according to the invention; and

FIG. 6 shows an embodiment of a system according to the invention.

### DETAILED DESCRIPTION

It is to be noted that the following description of exemplary embodiment will use the radio frequency identification technology (RFID) and NFC as examples for contactless communications. However, it is to be understood that the invention is not limited to any particular contactless communication like the near-field communication (NFC) technology, but can as well be used with other contactless near-field transmission schemes and technologies. Therefore, although the following specification will mainly focus on NFC and RFID as examples it is to be understood that the invention is not to be limited to these examples.

The term “substantially stationary” used in this specification is intended to include all devices that cannot be moved easily by a (single) user. In other words, it refers to devices that may not be regarded to be “mobile” in the sense that they can be easily carried around and moved from one place to another without requiring much effort. In the present invention “substantially stationary” refers to devices and appliances like washing machines and other (particularly heavy) equipment that may only be moved by using substantial efforts like requiring two or more people to lift and carry, or even machinery such as fork lifters etc. In the context of this invention this is also to be understood as including wall or floor-mounted devices, i.e. devices that are not to be separated without effort.

The term “difficult to access” used in this specification is intended to include all devices that may not easily be accessed without requiring much effort. Also, it is used to include devices that are sealed, shielded or otherwise enclosed, resulting in particular efforts required to open them and access their parts. The term is also intended to relate to devices that may be opened more or less easily, but than cannot be closed/assembled again without using a substantial amount of time, special tools, sealing agents etc. For example, a central control unit of a dishwasher or washing machine might be accessed by opening the device comparably easily. However, in order to re-assemble the device it will then be required to perform this in a water-tight manner, for example requiring special tools together with a renewed sealing. Thus such devices are to be covered by the term “difficult to access”.

Another example would be the central control unit of an automobile. Accessing such a module or unit, e.g. for replacing the chip storing the engine control parameters/programs, may require removing other parts of the engine in order to reach it like the air filter box, engine cover, electric generator etc. Therefore also such a device is to be considered as being difficult to access.

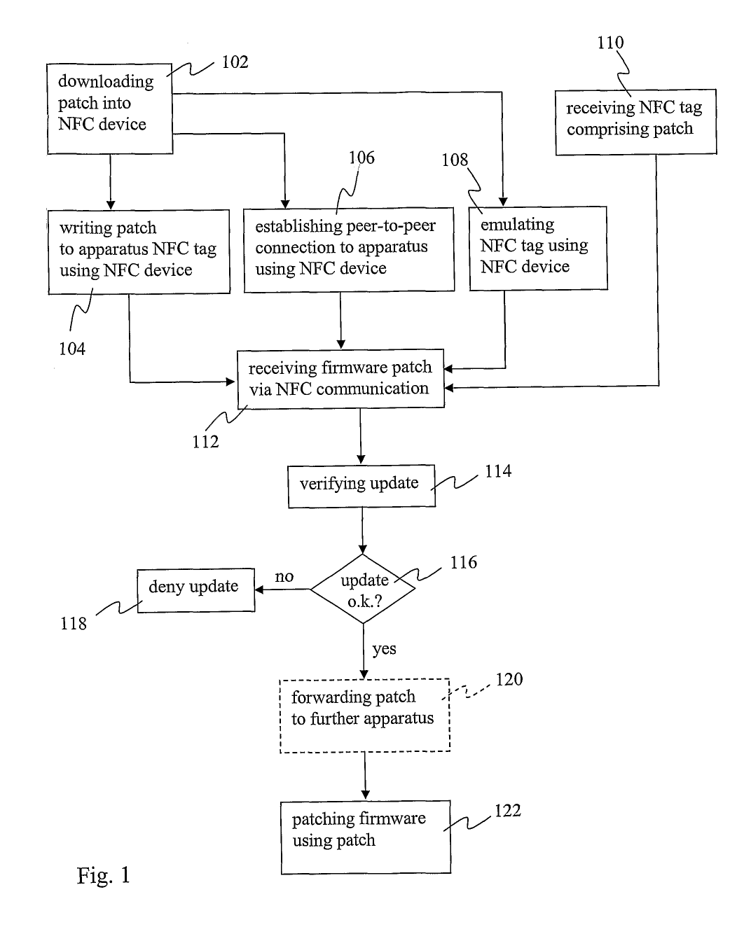

FIG. 1 illustrates steps of an exemplary embodiment of the method suggested by the invention. In step 102 an update or patch for a device's firmware is downloaded into an NFC device. In step 104 the patch is written to an NFC tag embedded in the apparatus to be updated with said patch, using the NFC device. The embedded tag has an interface towards the controller that can be selected to be active by the device. In this case the NFC device is at least capable of a writer mode operation, in order to write the downloaded patch onto the NFC tag in the apparatus to be updated. The patch is received at the apparatus to be updated in step 112, via NFC communication, in this case in an NFC writer to NFC tag communication. That is, the apparatus to be updated comprises a writable NFC tag.

In another alternative embodiment the NFC device is capable of performing peer-to-peer communication with another NFC device. Following step 102 the NFC device comprising the downloaded patch establishes, in step 106, a peer-to-peer communication to the apparatus to be updated. Again, in step 112 the patch is received at the apparatus to be updated via NFC communication, in this case in a peer-to-peer communication between the NFC device comprising the update and the apparatus the patch is intended for. That is, the apparatus to be updated comprises an NFC interface capable of peer-to-peer communication.

In yet another alternative embodiment the NFC device is at least capable of emulating an NFC tag to an NFC reader. Following the download of the patch in step 102 the NFC device is emulating an NFC tag having the downloaded patch in step 108. Again, in step 112 the patch is received at the apparatus to be updated via NFC communication, in this case in an emulated NFC tag to NFC reader communication. That is, the apparatus to be updated comprises an NFC interface capable of operating in a reader mode.

In still another embodiment the patch is received in form of an NFC tag comprising the patch, in step 110. The NFC tag comprising the patch can be provided to a customer or user via normal mail delivery or in any other suitable manner. Again, in step 112 the patch is received at the apparatus to be updated via NFC communication, in this case in an NFC tag to NFC reader communication. That is, the apparatus to be updated comprises an NFC interface capable of operating in a reader mode and the NFC tag is brought into range of said NFC interface in order to be read out.

Depending on the way the patch data are provided to the apparatus to be updated the different branches of the flow diagram of FIG. 1 are followed. Either way the apparatus to be updated receives the firmware patch in step 112 via an NFC communication. The patch data comprise the actual patch and one or more items serving as patch identification information, including patch data type, manufacturer identification, device identification, and patch version. The patch data may also comprise patch integrity information serving to verify the integrity of the patch.

In exemplary embodiments the patch data are received in an NFC data format according to the invention. This data format of the patch will be described in more detail later on. It is an NFC data format comprising one or more items or entries from a group including patch data type, manufacturer identification (ID), device ID, patch version number/string, and patch integrity information. That is, these entries are present in addition to the data format body comprising the actual patch data or patch code.

The apparatus to be updated may be a device that is substantially stationary and/or difficult to access, like a washing machine, central car control box and the like. However, it is to be noted that the invention is not limited to such devices, but can in principle be applied to any device with a patchable firmware.

In step 114 the received update is verified. Verifying can be performed by checking one or more items of the patch identification information and/or the integrity information, for example checking the integrity of the update by evaluating a check sum, supplier certificate etc., by checking a code of said update, said code identifying to which type of device said update is compatible, or by checking a version of said update. Checking the integrity is required in order to ensure that the update has been received correctly. In case it was previously downloaded by a user onto an NFC tag, this also ensures that this preceding download has been completed correctly.

Integrity can also be understood as relating to the source of the update. Surely it will be understood that only updates originating from a reliable source should be applied, i.e. usually the supplier of the update should be identical with or at least clearly related to the manufacturer of the device. Otherwise it would be possible to introduce so-called “malware”, i.e. manipulated firmware. Verifying the source of the update can be achieved by evaluating the update using certificates or cryptographic keys that can unambiguously be linked to the manufacturer.

Furthermore, before applying an update the device has to check that the update is intended for it, e.g. by evaluating a code in the update indicating the device type, model etc. of the device to be updated. As there may be several versions of a device being of the same (major) model or series, this code should include enough information to clearly identify the device it is intended for.

Also, even if the update is both of the correct version and its integrity can be acknowledged, it might still not be the right update for a particular device. In case the update is not the right one with respect to a succession of patches, updating should be denied. For example, if it is required to apply patches in a pre-determined succession, it may happen that an update to be applied requires a previous update patch that has not yet been applied, or that the attempted patch is older than the actual firmware of the device. In such cases update should be denied.

If the update cannot be verified, i.e. upon a negative verification in step 116, the process terminates in step 118 with the update being denied. The denied update can be indicated to a user via any means present in the device, like producing an audible sound, showing a message on a display or providing an optical signal pattern through control lights etc.

Otherwise, i.e. upon a positive verification in step 116, the firmware of the device is updated using the received update or patch, in step 122. The invention includes complete updates as well as incremental patches. That is, the update may include a complete new firmware, or it may comprise only those parts of the firmware that are to be patched/overwritten because of faults to be corrected. Also, if the firmware update contains new/additional features to be added to the device, the update may comprise code that is to be added to an otherwise unchanged firmware in the device. Any combination of these possibilities is also within the scope of the invention. Completed patching of the firmware can be indicated to a user with the same means as described above for indicating a failed update process.

It is to be noted that an exemplary embodiment of the invention may comprise an additional step 120, which is optional. This embodiment is suitable for a system comprising a plurality of components connected by a data interface, wherein at least one component is accessible to a user to receive the patch via NFC communication. At least one other component, but possibly also multiple components, comprises the patchable firmware. In this case the firmware patch is received at the accessible component in step 112, and the verifying steps are performed as in the previous embodiment. However, in case of a positive verification the firmware is not patched at the (first) component that received the patch, but the patch is forwarded to the at least one second component comprising the patchable firmware in step 120. Patching of the firmware using the received patch is performed in step 122, at the at least one second module.

The invention also includes further embodiments also applicable to a system of components or modules, wherein at least two modules comprise a patchable firmware, and at least one module comprises the NFC interface for receiving the patch. In this case the patch is assumed to comprise multiple sections intended to update the firmware of the different modules. Each module that is being forwarded the patch can extract the patch section comprising the patch code suitable for its firmware.

The modules can be arranged in a star topology, i.e. each module is forwarded the complete patch, and then extracts only the relevant patch code. The modules can also be arranged in a daisy-chain topology. In this case the invention includes forwarding the complete patch from each module to the next and extract relevant patch code at each module. However, in addition it also includes that each module removes the relevant code sections it uses by itself and only passes on the remaining patch code sections.

These example cases can be combined, i.e. the system may comprise a mixed star/daisy-chain topology. Also, the receiving module having the NFC interface may also comprise a controller that extracts relevant code sections for each connected module and then only forwards the relevant patch code sections to each module, thus saving bandwidth on the data interface connection the modules. The interface can be any data interface, including but not limited to wired or wireless interfaces like Controller Area Network (CAN) bus, Bluetooth, WLAN etc.

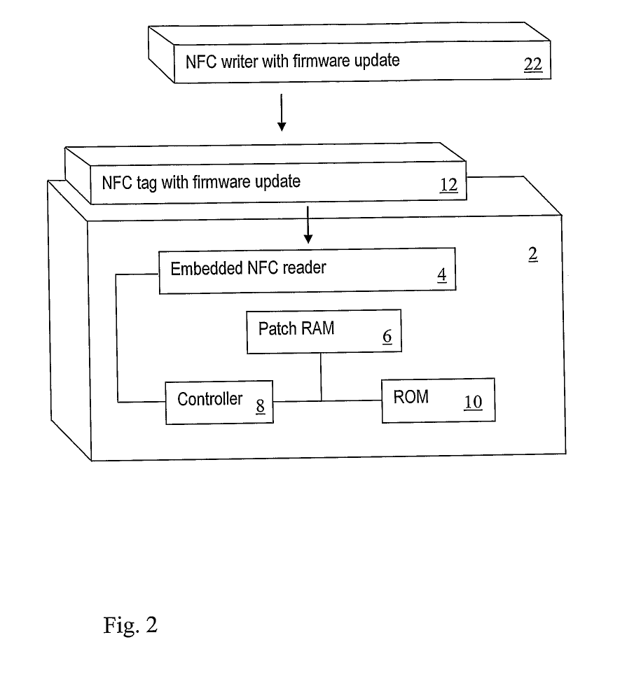

In FIG. 2 an exemplary embodiment of a device 2 according to the invention is depicted schematically. The device 2 comprises a read-only memory ROM 10, wherein the firmware is stored. A patch RAM 6 is provided, to store patch information for fixing bugs detected after tape-out of the device 2 or to add new functions. It is to be noted that the depicted combination of ROM and patch RAM is only used as an example. The invention also includes having only one type of storage element, e.g. a flash memory, EEPROM or like, instead of or in addition to ROM and patch RAM.

Device 2 further comprises a controller circuitry 8, connected to both ROM 10 and patch RAM 6. An embedded NFC reader tag 4 is provided, which is connected to the controller circuitry 8. For example the NFC reader 4 could be located behind a front cover of device 2. It is not required that any direct connection exists to the outside of the housing of device 2, as the NFC reader 4 operates wirelessly. Therefore device 2 may e.g. be made waterproof

If the user wants to upgrade the firmware of the device 2, he can simply place an NFC tag 12, for example an RFID tag, onto device 2 (depending on the range of the NFC reader it may be required to place it onto a particular section of the device 2). The NFC tag 12 stores an update for the firmware which is transmitted to the device 2 over the NFC interface. The update or patch data comprise the actual patch and one or more items serving as patch identification information, including patch data type, manufacturer identification, device identification, and patch version. The patch data may also comprise patch integrity information serving to verify the integrity of the patch. The patch data may also be in the NFC data format of the invention. In the depicted embodiment the patch is transferred to the device to be updated 2 in an NFC tag to NFC reader communication.

In another alternative embodiment the NFC tag 12 is programmed with the patch data by using an NFC writer 22 having the firmware update, e.g. a mobile NFC device with a network connection to the Internet or like, before the NFC tag 12 is applied to the device 2 to be updated.

The controller circuitry 8 is operable to verify the firmware update, e.g. by checking parameters like the data integrity, authorization of the supplier, device compatibility or version number of the update. Upon positive verification the firmware update is written into the patch RAM 6 (in case of an incremental update), or more generally in the memory element storing the firmware or any additions/patches therefore.

Providing the firmware update on an NFC tag has the advantage that a supplier of the firmware update faces very low costs for providing the update. Inter alia the update tag can be sent by normal mail. On the other hand, this requires that an NFC reader is installed in the device.

According to the invention it is also possible that the user downloads the update into an NFC writing capable device 22 and writes it to an NFC tag 12. For example the NFC tag 12 could be provided at the purchase of the device 2, as an empty but writable NFC tag.

In case of an NFC reader 4 in device 2 there are different possibilities for triggering the update sequence. According to one exemplary embodiment the NFC reader 4 will check for the presence of an NFC tag 12 storing an update upon power-up of the device. In another embodiment the NFC reader 4 will regularly check for the presence thereof. In still further embodiments the update process can be triggered upon the user pressing a special combination of keys or other controls of device 2, e.g. simultaneously pressing stop, play and fast forward.

These possibilities include using a special combination of control keys by the user, e.g.

pressing play, stop and eject together. There are many similar ways for providing a special input situation that triggers the update, like holding down certain keys for a minimum time span, actuating one or more keys or generally input elements a certain number of times, in a particular succession and the like. It may be ensured that the special input situation does not occur during normal operation of the device.

According to yet another embodiment the device to be updated is equipped with a slot, aperture, compartment or like receptacle for receiving an updated medium carrying the NFC tag 12, e.g. in the form of a plastic card like a credit card, a cylindrical body etc. A trigger circuitry is provided for detecting an approach of such an update medium. The trigger circuitry can be provided as a mechanic, electric, opto-electric or magnetic switch or combination thereof. In the exemplary case of a mechanical switch the receptacle for insertion of the update carrier medium can accommodate the switch, such that the controller circuitry will be activated upon insertion of the medium.

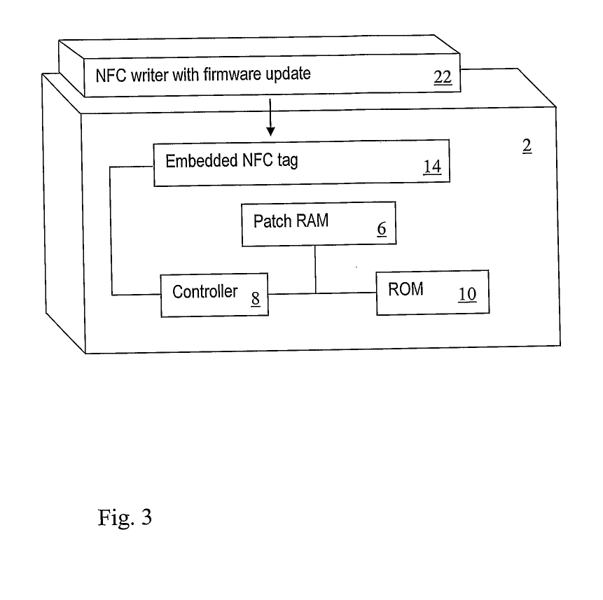

In FIG. 3 another exemplary embodiment of a device 2 according to the invention is depicted schematically. The device 2 comprises a read-only memory ROM 10, wherein the firmware is stored. A patch RAM 6 is provided, to store patch information for fixing bugs detected after tape-out of the device 2 or to add new functions. It is to be noted that the depicted combination of ROM and patch RAM is only used as an example. The invention also includes having only one type of storage element, e.g. a flash memory, EEPROM or like, instead of or in addition to ROM and patch RAM.

Device 2 further comprises a controller circuitry 8, connected to both ROM 10 and patch RAM 6. An embedded NFC tag 14, for example an RFID tag, is provided, which is connected to the controller circuitry 8. For example the NFC tag 14 could be located behind a front cover of device 2. It is not required that any direct connection exists to the outside of the housing of device 2, as the NFC tag 14 operates wirelessly. Therefore device 2 may e.g. be made waterproof.

If the user wants to upgrade the firmware of the device 2, he can simply place an NFC writer 22, for example an RFID writer, onto device 2 (depending on the range of the NFC writer/tag it may be required to place it onto a particular section of the device 2). The NFC writer 22 is located in a mobile device which stores an update for the firmware, which is transmitted to the device 2 over the NFC interface. The update or patch data comprise the actual patch and one or more items serving as patch identification information, including patch data type, manufacturer identification, device identification, and patch version. The patch data may also comprise patch integrity information serving to verify the integrity of the patch. The patch data may also be in the NFC data format of the invention. In the depicted embodiment the patch is transferred to the device to be updated 2 in an NFC writer to NFC tag communication. That is, the device to be updated 2 comprises an NFC tag that is powered by the NFC writer 22.

The controller circuitry 8 is operable to verify the firmware update, e.g. by checking parameters like the data integrity, authorization of the supplier, device compatibility or version number of the update. Upon positive verification the firmware update is written into the patch RAM 6 (in case of an incremental update), or more generally in the memory element storing the firmware or any additions/patches therefore.

In case of an NFC tag 14 in device 2 the approach of an active NFC writer 22 may automatically trigger the activation of the NFC tag 14 and the controller circuitry 8 by the used interrogation or wake-up sequence. However, also the update process triggering schemes described for the embodiment of FIG. 2 can be used as well, like activating the update procedure upon power-up, upon occurrence of a special input situation or by using a trigger circuit for detecting the approach of the NFC writer 22.

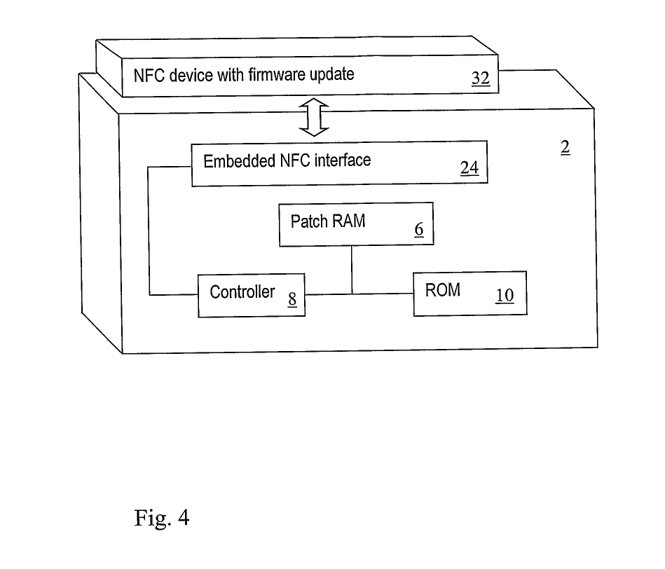

In FIG. 4 another exemplary embodiment of a device 2 according to the invention is depicted schematically. The device 2 comprises a read-only memory ROM 10, wherein the firmware is stored. A patch RAM 6 is provided, to store patch information for fixing bugs detected after tape-out of the device 2 or to add new functions. It is to be noted that the depicted combination of ROM and patch RAM is only used as an example. The invention also includes having only one type of storage element, e.g. a flash memory, EEPROM or like, instead of or in addition to ROM and patch RAM.

Device 2 further comprises a controller circuitry 8, connected to both ROM 10 and patch RAM 6. An embedded NFC interface 24 is provided, which is connected to the controller circuitry 8, and which is capable of NFC peer-to-peer communication. For example the NFC interface 24 could be located behind a front cover of device 2. It is not required that any direct connection exists to the outside of the housing of device 2, as the NFC interface 24 operates wirelessly. Therefore device 2 may e.g. be made waterproof.

If the user wants to upgrade the firmware of the device 2, he can simply place a peer-to-peer capable NFC device 32 onto device 2 (depending on the range of the NFC device and NFC interface it may be required to place it onto a particular section of the device 2). The NFC device 32 stores an update for the firmware, which is transmitted to the device 2 over the NFC interface. The update or patch data comprise the actual patch and one or more items serving as patch identification information, including patch data type, manufacturer identification, device identification, and patch version. The patch data may also comprise patch integrity information serving to verify the integrity of the patch. The patch data may also be in the NFC data format of the invention. The NFC device 32 and the embedded NFC interface 24 are operable to establish an NFC peer-to-peer communication in order to transfer the patch. That is, in the depicted embodiment the patch is transferred to the device to be updated 2 in a peer-to-peer communication between the NFC device comprising the patch and the device to be update 2, indicated by the bi-directional arrow.

In this embodiment the firmware update process may be triggered by the establishment of the peer-to-peer communication. However, also the update process triggering schemes described for the embodiments of FIG. 2 and FIG. 3 can be used as well.

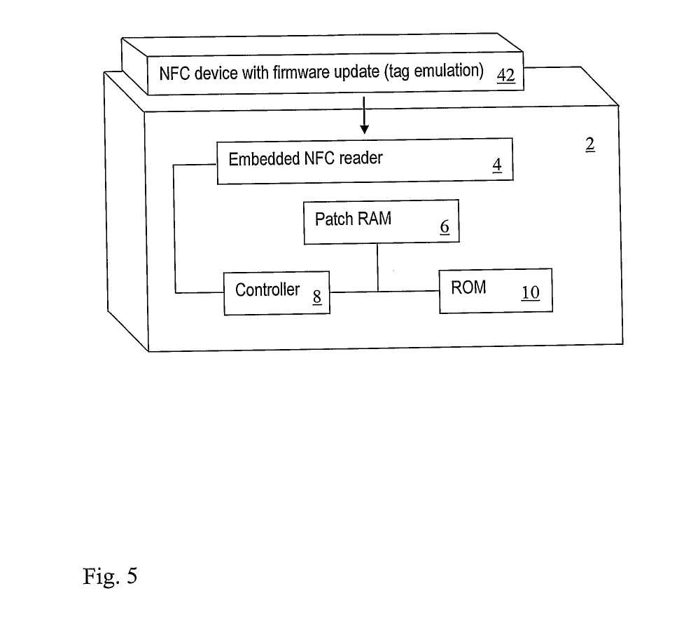

In FIG. 5 another exemplary embodiment of a device 2 according to the invention is depicted schematically. The device 2 comprises a read-only memory ROM 10, wherein the firmware is stored. A patch RAM 6 is provided, to store patch information for fixing bugs detected after tape-out of the device 2 or to add new functions. It is to be noted that the depicted combination of ROM and patch RAM is only used as an example. The invention also includes having only one type of storage element, e.g. a flash memory, EEPROM or like, instead of or in addition to ROM and patch RAM.

Device 2 further comprises a controller circuitry 8, connected to both ROM 10 and patch RAM 6. An embedded NFC reader 4 is provided, which is connected to the controller circuitry 8. For example the NFC reader 4 could be located behind a front cover of device 2. It is not required that any direct connection exists to the outside of the housing of device 2, as the NFC reader 4 operates wirelessly. Therefore device 2 may e.g. be made waterproof.

If the user wants to upgrade the firmware of the device 2, he can simply place an NFC device 42 being capable of operating in an NFC tag emulation mode onto device 2. The NFC device 42 stores an update for the firmware, which is transmitted to the device 2 over the NFC interface, wherein the update or patch data comprise the actual patch and one or more items serving as patch identification information, including patch data type, manufacturer identification, device identification, and patch version. The patch data may also comprise patch integrity information serving to verify the integrity of the patch. The patch data may also be in the NFC data format of the invention. Otherwise the update procedure is performed identical with the embodiment described in conjunction with FIG. 2. That is, in this embodiment the patch is transferred to the device to be updated 2 in an (emulated) NFC tag to NFC reader communication, however, the NFC device 42 takes the role of the NFC tag by performing an NFC tag emulation.

In this embodiment the firmware update process may be triggered in the same manner as already described for the embodiment of FIG. 2.

The data format of the firmware update according to exemplary embodiments of the invention, e.g. on an NFC tag, can be defined as a new NFC data type. For example this new data format comprises a “SW patch” field, an “appliance/device code” field, a “patch number/version” field, and the patch code payload data field.

In an exemplary embodiment of such a data format the header comprises:

NDEF data type: SW patch (example “nokia.com.patch”)

Length: X

In an exemplary embodiment of such a data format the body comprises:

Device ID: 4711-0815.003

Patch version string: 1.3a

Patch data payload: ###

In an exemplary embodiment optional fields could include:

Hamming code/checksum (CRC)

Issuer certificate/cryptographic key

Applying a patch to the wrong device or applying patches in the wrong order could be troublesome. Even devices of one product type often have differing versions as they evolve over time, so the full product code and not just the model number may be required to ensure full patch compatibility. Therefore the data format must ensure that the correct device can be identified that a patch is intended for. In the example above the manufacturer code could be “4711”, the device model number could be “0815”, and the device revision number could be “003”.

The patch number shown here is “1.3”, i.e. the patch is the third patch available, assumed that version “1.0” indicates the initial firmware version. If the device to be updated comprises firmware version “1.2” the patch would thus be compatible. If the current firmware is of version “1.4” the patch will normally be considered to be incompatible, as it would entail a “downgrading” of the firmware. In case the current firmware is “1.1” there are two options, depending on the kind of the firmware update intended by the manufacturer.

A manufacturer may release firmware patches in a form including all previous patches, or he can provide them as incremental patches requiring the directly preceding patch to work. Depending on the type of patch the firmware patch version “1.3” might be compatible for a firmware “1.1” as it includes patch “1.2”, or may require applying patch “1.2” first.

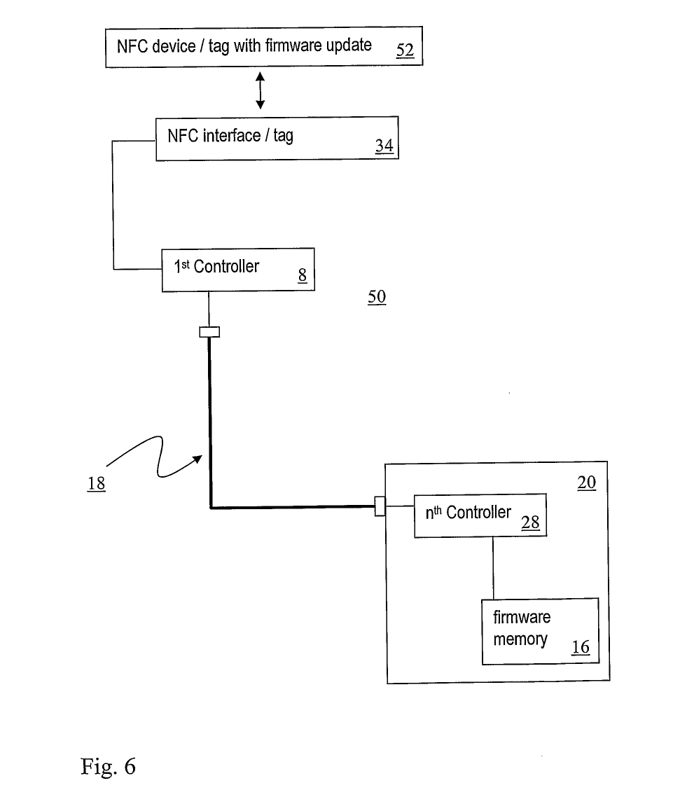

FIG. 6 shows an embodiment of a system of the invention. The system comprises a first module 50 having an embedded NFC tag or NFC interface 34, and a 1^{st} controller circuitry 8. Embodiments comprising the NFC tag 34 are intended to be provided with firmware patches via an NFC writing capable NFC device 52. In embodiments comprising the NFC interface 34 this NFC interface can be configured to operate in an NFC reading mode, such that it is intended to be provided with firmware updates via an NFC tag 52, which may be a passive NFC tag 52 or an emulated NFC tag, i.e. an NFC device 52 emulating a passive NFC tag.

In still other embodiments the NFC interface 34 can be configured to operate in a peer-to-peer connection mode, and it is intended to be provided with firmware updates via another peer-to-peer capable NFC device 52, e.g. a mobile phone or like. That is, all combinations of firmware receiving interface and firmware supplying interface as described for the embodiments of FIGS. 2-5 can be used in module 50 as well.

Via an interface, in the example depicted here a bus 18, module 50 is connected with at least one second module 20, having a controller circuitry 28, i.e. n^{th} controller, wherein n>2, and comprising a firmware memory 16, for example a flash ROM, EEPROM, ROM combined with patch RAM or like. The bus 18 can for example be a Controller Area Network (CAN) bus. In other embodiments the interface 18 can be any other wired or wireless interface, and does not need to be a bus at all. Different modules can be connected by a bus interface, but can also have dedicated (and possibly different) point-to-point connections, both wired and wireless and combinations thereof.

It is to be understood that more than one module like module 20 can be connected via the interface 18, although for sake of simplicity only one such module 20 is shown. For example in a vehicular environment there can be multiple modules, including but not limited to central locking module, engine control module, audio system control module, car alarm module etc. Also, the modules can be connected via a bus system, in a star topology, in a daisy-chain topology, and any combination thereof.

An example for such a system could be an automotive system having a CAN bus between a plurality of its components, like audio/navigation system, central control unit, electronic/fuse box, diagnosis interface etc. According to the invention only one of these modules needs to be equipped with an NFC interface, preferably one that is easy to access by a user, like the diagnosis interface or audio system. At least one, but also more than one up to every component of the system may have a specific own firmware.

For example, the central control unit comprises a firmware memory storing the engine control parameters/programs. As this central unit will probably be located in a difficult to access or even unreachable area in the engine compartment, the invention provides a way to update the firmware without disassembling parts of the car. Assumed that the NFC interface is located in the audio system (i.e. module 50 in FIG. 6), the user can easily apply a patch accessing the audio system that is provided with the NFC interface/tag 34. Another possibility for a module 50 could be a diagnosis interface that is usually also easily accessible.

Controller 8 is configured to verify the patch as described for the inventive method above, and will forward the patch via bus 18, in case of a positive verification. The n^{th} controller 28 in module 20 (in this example the central control unit) receives the patch and is configured to apply it to the firmware memory 16. In another embodiment the controller 8 passes on the patch without performing verification, while the controller 28 performs the verification before applying the patch.

In another exemplary embodiment it is also possible that module 50 also has a firmware memory. In this case (not shown) controller 8 could extract the section of a patch intended for patching the firmware of module 50, and pass on the whole patch or only the patch data relevant for the other module(s). In an exemplary embodiment controller 8 does only comprise the minimum function to receive the patch via the NFC interface/tag 4 and pass it on via the bus, without having additional logic for verification etc. In this case each module 20 is equipped with a controller being able to check and apply the patch.

It should be apparent that FIG. 6 is only an example showing a substantially minimal number of elements required to explain the principle of the invention. The system can have more than two modules, in the automotive example case there will usually be a plurality of distributed modules. Also, while each modules may have a firmware memory, it is only required that at least one module 20 does have one. Similarly, at least one module 50 needs the NFC interface/tag 34, however, it is also possible that more than one module does have such an NFC interface/tag.

The latter enables to have two or more NFC input sites. In case of two or more firmware memories within the system this allows for example to provide on NFC input site for user-accessible firmware updates, i.e. to receive updates the manufacturer of the car regards to be safe to be applied by a user which does not need to be technically skilled, and one or more other NFC input sites for receiving updates for more critical car systems the manufacturer does not allow to be patched by a user. The latter NFC input site will then only be intended to be used by a professional, like a car mechanic or like.

From the description it should be apparent to any artisan that the approach described above can be applied to many different devices and is not limited to the particular examples used for descriptive purposes in this specification.

1. Method, comprising:
receiving patch data via contactless communication comprising a patch for a patchable firmware and patch identification information; and
patching said firmware using said patch.

2. Method according to claim 1, wherein said patch identification information includes at least one of:
patch data type;
manufacturer identification;
device identification; and
patch version.

3. Method according to claim 2, further comprising
verifying said patch by checking at least one of patch data type, manufacturer identification, device identification and patch version;
wherein patching of said firmware is performed responsive to a positive verification of each checked item.

4. Method according to claim 3, wherein said verifying comprises checking if said patch identification information includes a patch data type, and establishing a positive verification if said patch data type is included.

5. Method according to claim 3 or 4, wherein said checking comprises checking a manufacturer identification in said patch identification information, and establishing a positive verification if said manufacturer identification corresponds to pre-determined manufacturer information.

6. Method according to anyone of claims 3 to 5, wherein said checking comprises checking a device identification in said patch identification information, and establishing a positive verification if said device identification corresponds to a pre-determined device identification.

7. Method according to anyone of claims 3 to 6, wherein said checking comprises checking a patch version in said patch identification information, and establishing a positive verification if said patch version is more recent than and/or directly succeeds the version of said firmware.

8. Method according to anyone of claims 3 to 7, wherein said patch data further comprise patch integrity information, and wherein said verifying of said patch further comprises checking said patch integrity information, and establishing a positive verification if said patch integrity information is valid.

9. Method according to anyone of claims 1 to 8, wherein said patch data are received at an NFC tag, comprising
downloading said patch data into a mobile device having an NFC interface capable of writer mode operation; and
providing said patch data to said NFC tag via said NFC interface in writer mode.

10. Method according to anyone of claims 1 to 8, wherein said patch data are received at an NFC interface capable of peer-to-peer mode operation, comprising
downloading said patch into a mobile device having an NFC interface capable of peer-to-peer mode operation; and
providing said patch from said mobile device to said NFC interface in peer-to-peer communication.

11. Method according to anyone of claims 1 to 8, wherein said firmware patch is received at an NFC interface capable of reader mode operation, comprising
downloading said patch into a mobile device having an NFC writer;
writing said patch to an NFC tag using said NFC writer; and
providing said patch to said NFC interface using said NFC tag.

12. Method according to anyone of claims 1 to 8, wherein said firmware patch is received at an NFC interface capable of reader mode operation, comprising
downloading said patch into a mobile device having an NFC interface capable of NFC tag emulation mode operation;
emulating an NFC tag using said mobile device; and
providing said patch to said NFC interface via said emulated NFC tag.

13. Method according to anyone of claims 1 to 8, wherein said patch is received at an NFC interface capable of reader mode operation, comprising
providing said patch to said NFC interface using an NFC tag.

14. Method according to anyone of claims 1 to 13, wherein said patch data are received at a first module having a contactless communication interface, further comprising:
forwarding said patch data to a second module.

15. Computer program product, comprising program code to instruct a device on which said program product runs to perform a method according to anyone of claims 1 to 14.

16. Computer program product according to claim 15, wherein said program code is stored on a computer readable medium.

17. Apparatus, comprising
a memory component configured for storing a patchable firmware;
a contactless communication interface; and
a controller circuitry;
wherein said controller circuitry is configured to receive patch data via said contactless communication interface comprising a patch for said firmware and patch identification information, and to patch said firmware using said patch.

18. Apparatus according to claim 17, wherein said patch identification information includes at least one of:
patch data type;
manufacturer identification;
device identification; and
patch version;
wherein said controller circuitry is configured to verify said patch by checking at least one of patch data type, manufacturer identification, device identification and patch version and to perform said patching of said firmware responsive to a positive verification of each checked item.

19. Apparatus according to claim 18, wherein said checking comprises checking if said patch identification information includes a patch data type, and establishing a positive verification if said patch data type is included.

20. Apparatus according to claim 18 or 19, wherein said checking comprises checking a manufacturer identification in said patch identification information, and establishing a positive verification if said manufacturer identification corresponds to pre-determined manufacturer information.

21. Apparatus according to anyone of claims 18 to 20, wherein said checking comprises checking a device identification in said patch identification information, and establishing a positive verification if said device identification corresponds to a pre-determined device identification.

22. Apparatus according to anyone of claims 18 to 21, wherein said checking comprises checking a patch version in said patch identification information, and establishing a positive verification if said patch version is more recent than and/or directly succeeds said firmware version.

23. Apparatus according to anyone of claims 18 to 22, wherein said patch data further comprise patch integrity information, and wherein said verifying of said patch further comprises checking said patch integrity information, and establishing a positive verification if said patch integrity information is valid.

24. Apparatus according to anyone of claims 18 to 23, further comprising
a trigger circuitry configured to detect an approach of an NFC tag to said apparatus;
wherein said controller circuitry is configured to be activated responsive to a detected approach.

25. Apparatus according to claim 24, wherein said trigger circuitry is configured to detect an approach of an NFC tag by detecting an insertion of a carrier medium carrying said NFC tag into said apparatus.

26. Apparatus according to anyone of claims 18 to 25, wherein said contactless communication interface comprises one of:
an NFC interface configured for reader mode operation;
an NFC interface configured for peer-to-peer mode operation;
an NFC tag;
an NFC interface configured for NFC tag emulation mode operation;
an RFID interface configured for reader mode operation;
an RFID tag; and
an RFID interface configured for RFID tag emulation mode operation.

27. System, comprising
a first module comprising a contactless communication interface;
at least one second module comprising a memory component configured for storing a patchable firmware;
an interface connecting said first and said second module;
a first controller circuitry in said first module; and
a second controller circuitry in said at least one second module;
wherein said first controller circuitry is configured to receive patch data via said contactless communication interface comprising a patch for said firmware and patch identification information, and to forward said patch data from said first module to said at least one second module via said interface, and wherein said at least one second controller circuitry is configured to patch said firmware using said patch.

28. System according to claim 27, wherein said contactless communication interface comprises one of:
an NFC interface configured for reader mode operation;
an NFC interface configured for peer-to-peer mode operation;
an NFC tag;
an NFC interface configured for NFC tag emulation mode operation;
an RFID interface configured for reader mode operation;
an RFID tag; and
an RFID interface configured for RFID tag emulation mode operation.

29. System according to claim 26 or 27, wherein said patch identification information includes at least one of:
patch data type;
manufacturer identification;
device identification; and
patch version;
wherein said second controller circuitry is configured to verify said patch by checking at least one of patch data type, manufacturer identification, device identification and patch version and to perform said patching of said firmware responsive to a positive verification of each checked item.

30. System according to anyone of claims 27 to 29, wherein said checking comprises checking if said patch identification information includes a patch data type, and establishing a positive verification if said patch data type is included.

31. System according to anyone of claims 27 to 30, wherein said checking comprises checking a manufacturer identification in said patch identification information, and establishing a positive verification if said manufacturer identification corresponds to pre-determined manufacturer information.

32. System according to anyone of claims 27 to 31, wherein said checking comprises checking a device identification in said patch identification information, and establishing a positive verification if said device identification corresponds to a pre-determined device identification.

33. System according to anyone of claims 27 to 32, wherein said checking comprises checking a patch version in said patch identification information, and establishing a positive verification if said patch version is more recent than and/or directly succeeds said firmware version.

34. System according to anyone of claims 27 to 33, wherein said patch data further comprise patch integrity information, and wherein said verifying of said patch further comprises checking said patch integrity information, and establishing a positive verification if said patch integrity information is valid.

35. Apparatus, comprising:
means for receiving patch data for a patchable firmware via contactless communication comprising said patch and patch identification information; and
means for patching said firmware using said patch.
